(19) United States
(12) Patent Application Publication
(10) Pub. No.: US 2025/0216935 A1
(43) Pub. Date: Jul. 3, 2025

(54) HORIZONTAL AND VERTICAL CONVERSATION FOCUSING USING EYE TRACKING

(71) Applicant: Sony Group Corporation, Tokyo (JP)

(72) Inventors: Brant L. Candelore, Poway, CA (US); James R. Milne, Ramona, CA (US); Justin Kenefick, San Diego, CA (US); William Clay, San Diego, CA (US)

(73) Assignee: Sony Group Corporation, Tokyo (JP)

(21) Appl. No.: 18/403,588

(22) Filed: Jan. 3, 2024

(51) Int. Cl. G06F 3/01; G06F 3/16

(52) U.S. Cl. CPC G06F 3/013; G06F 3/165

(57) ABSTRACT

Implementations generally relate to providing horizontal and vertical conversation focusing using eye tracking. In some implementations, a method includes identifying at a wearable device associated with a user at least one eye gesture of the user. The method further includes modifying a current auditory pickup configuration associated with the hearing device based on the at least one eye gesture of the user, where the hearing device is configured to detect one or more sounds.

### CROSS REFERENCE TO RELATED APPLICATIONS

This application is related to U.S. patent application Ser. No. ______, entitled “GESTURES-BASED CONTROL OF HEARABLES,” filed Jan. 3, 2024 (Attorney Docket No. 020699-124000US/Client Reference No. SYP352727US01), which is hereby incorporated by reference as if set forth in full in this application for all purposes.

### BACKGROUND

Hearables may be used to make conversation more understandable for a particular situation. For example, some devices automatically identify a type of location (e.g., home, office, restaurant, shopping mall, etc.) and may adjust the hearables accordingly based on particular preset modes of operation. In some situations, the user may specifically identify the type of locations. A problem is that identifying the type of location is not sufficient to ensure good hearing. Hearables having directional microphones may help to improve the pickup of sounds and are effective in noisy environments. Directional microphones enable a wearer to focus on sounds from a specific direction (e.g., right in front of the wearer) without the distraction of background noise.

### SUMMARY

Implementations generally relate to providing horizontal and vertical conversation focusing using eye tracking. In some implementations, a system includes one or more processors, and includes logic encoded in one or more non-transitory computer-readable storage media for execution by the one or more processors. When executed, the logic is operable to cause the one or more processors to perform operations including: identifying at a wearable device associated with a user at least one eye gesture of the user. The method further includes modifying a current auditory pickup configuration associated with the hearing device based on the at least one eye gesture of the user, where the hearing device is configured to detect one or more sounds.

With further regard to the system, in some implementations, the wearable device includes eyewear. In some implementations, the at least one eye gesture includes a gaze of the user in a direction toward one or more people positioned in front of the user. In some implementations, the at least one eye gesture corresponds to a command to modify the current auditory pickup configuration to a target auditory pickup configuration. In some implementations, the auditory pickup configuration includes one or more of a horizontal range and a vertical range. In some implementations, the at least one eye gesture corresponds to a command to switch from a current microphone type to a target microphone type. In some implementations, the logic when executed is further operable to cause the one or more processors to perform operations including tracking at the wearable device one or more people positioned in front of the user, where the one or more people respectively correspond to one or more voices associated with the one or more sounds, and where the modifying of the current auditory pickup configuration is based on a number of the one or more people.

In some implementations, a non-transitory computer-readable storage medium with program instructions thereon is provided. When executed by one or more processors, the instructions are operable to cause the one or more processors to perform operations including: identifying at a wearable device associated with a user at least one eye gesture of the user. The method further includes modifying a current auditory pickup configuration associated with the hearing device based on the at least one eye gesture of the user, where the hearing device is configured to detect one or more sounds.

With further regard to the computer-readable storage medium, in some implementations, the wearable device includes eyewear. In some implementations, the at least one eye gesture includes a gaze of the user in a direction toward one or more people positioned in front of the user. In some implementations, the at least one eye gesture corresponds to a command to modify the current auditory pickup configuration to a target auditory pickup configuration. In some implementations, the auditory pickup configuration includes one or more of a horizontal range and a vertical range. In some implementations, the at least one eye gesture corresponds to a command to switch from a current microphone type to a target microphone type. In some implementations, the instructions when executed are further operable to cause the one or more processors to perform operations including tracking at the wearable device one or more people positioned in front of the user, where the one or more people respectively correspond to one or more voices associated with the one or more sounds, and where the modifying of the current auditory pickup configuration is based on a number of the one or more people.

In some implementations, a computer-implemented method includes: identifying at a wearable device associated with a user at least one eye gesture of the user. The method further includes modifying a current auditory pickup configuration associated with the hearing device based on the at least one eye gesture of the user, where the hearing device is configured to detect one or more sounds.

With further regard to the method, in some implementations, the wearable device includes eyewear. In some implementations, the at least one eye gesture includes a gaze of the user in a direction toward one or more people positioned in front of the user. In some implementations, the at least one eye gesture corresponds to a command to modify the current auditory pickup configuration to a target auditory pickup configuration. In some implementations, the auditory pickup configuration includes one or more of a horizontal range and a vertical range. In some implementations, the at least one eye gesture corresponds to a command to switch from a current microphone type to a target microphone type.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a top-view block diagram of an example environment involving the control of hearables, where a user is speaking with one other person, according to some implementations.

FIG. 2 is a top-view block diagram of an example environment involving the control of hearables, where a user is speaking with multiple other people, according to some implementations.

FIG. 3 is an example flow diagram for controlling hearables based on gestures of a user, according to some implementations.

FIG. 4 is a side-view diagram of an example environment involving the control of hearables, where a user is speaking with multiple other people, according to some implementations.

FIG. 5 is a side-view diagram of an example environment involving the control of hearables, where a user is speaking with multiple other people, according to some implementations.

FIG. 6 is a top-view block diagram of an example environment involving the control of hearables, where a user is speaking with multiple other people, according to some implementations.

FIG. 7 is a block diagram of an example environment involving the control of hearables, where a user is speaking with multiple other people as seen through a wearable device, according to some implementations.

FIG. 8 is an example flow diagram for providing horizontal and vertical conversation focusing using eye tracking, according to some implementations.

FIG. 9 is a block diagram of an example network environment, which may be used for some implementations described herein.

FIG. 10 is a block diagram of an example computer system, which may be used for some implementations described herein

### DETAILED DESCRIPTION

Implementations described herein enable, facilitate, and manage the control of hearables based on gestures of a user. Implementations described herein also enable, facilitate, and manage horizontal and vertical conversation focusing of hearables using eye tracking.

As described in more detail herein, in various implementations, a system detects one or more sounds at a hearing device associated with a user. In various implementations, the one or more sounds may include voices. When the system detects at least one gesture of the user such as a head gesture, the system modifies the current auditory pickup pattern or configuration associated with the hearing device based on the gesture. The gesture may be a head movement of the user, which may correspond to the user looking at one or more people at particular locations in front of the user, where the user is having a conversation with such people. Such head movements cause detectable movement of the hearing device. Although some implementations disclosed herein are described in the context of a single gesture corresponding to a command for controlling a hearing device, these implementations also apply to multiple gestures corresponding to different commands and may apply to multiple hearing devices (e.g., a left-ear hearing device, a right-ear hearing device, etc.).

In various implementations, a system detects one or more sounds at a hearing device associated with a user. In various implementations, the one or more sounds may include voices. The system further identifies at a wearable device associated with the user at least one eye gesture of the user. The wearable device may be glasses or goggles worn by the user, where the wearable device has a camera that tracks the eyes of the user. The eye gesture may be associated with the gaze of the eyes of the user. The gaze may correspond to the user looking at one or more people at particular locations in front of the user, where user is having a conversation with such people. The system further modifies a current auditory pickup configuration associated with the hearing device based on the at least one eye gesture of the user.

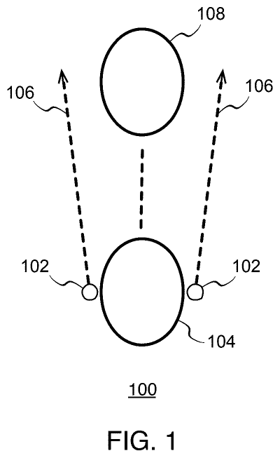

FIG. 1 is a top-view block diagram of an example environment 100 involving the control of hearables, where a user is speaking with one other person, according to some implementations. In various implementations, environment 100 includes a system 102, which includes one or more hearing devices 102.

While a pair of hearing devices 102 may operate in concert, implementations described herein may apply to each hearing device 102 independently. As such, for ease of illustration, system 102 may be referred to in the singular as hearing device 102 or may be referred collectively in the plural as hearing devices 102, depending on the context. Also, the terms hearing device and hearable may be used interchangeably.

In various implementations, each hearing device 102 may communicate with the other hearing device 102 via any suitable communication network such as a Bluetooth network, a Bluetooth low energy network, a Wi-Fi network, an ultra-wideband network, a near-field communication network, the Internet, a proprietary network, etc.

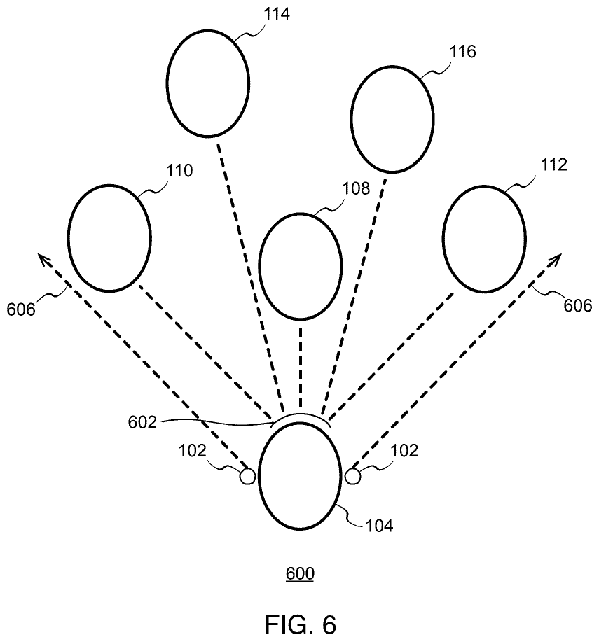

While system 102 performs implementations described herein, in other implementations, any suitable component or combination of components associated with system 102 or any suitable processor or processors associated with system 102 may facilitate performing the implementations described herein. For example, as described in more detail herein, system 102 may include a wearable device such as glasses or goggles having a camera. The wearable device may work in concert with hearing devices 102, where all of which are a part of system 102. Example implementations of a wearable device are described in more detail below in connection with FIGS. 6, 7, and 8.

As shown, hearing devices 102 may be worn by a user 104. In various implementations, hearing devices 102 are electronic in-ear devices designed for multiple purposes, including hearing health and other applications. In some implementations, hearing devices 102 may also be worn over the ears or in the vicinity of the ears to provide audio and/or auditory information to the user. Hearing devices 102 may include smart headphones or earbuds or hearing aids. Hearing devices 102 may be referenced as a subset of wearables.

In various implementations, the hearing devices 102 have an auditory pickup pattern or configuration 106 for detecting and receiving audio information such as a sound or a person's voice. As shown, user 104 who is wearing hearing devices 102 is talking with another person 108. Because user 104 is talking to one person, the range or scope of the auditory pickup pattern or configuration 106 may be narrow by default. This is because user 104 would be interested in hearing devices 102 picking up a sound or the voice of person 108 who is participating in the conversation with user 104. It is presumed in this example scenario that user 104 is not interested in hearing devices 102 picking up a sound, or voices of other people who may be further away or to the side, and who are not participating in the conversation.

In various scenarios, there may be scenarios where user 104 is conversing with multiple other people. For example, user 104 may be talking with 2 or more people positioned in front of user 104. There may also be scenarios where user 104 is talking with multiple people while others are present but are not participating in the conversation, such as in a private or public gathering (e.g., event, party, etc.).

As described in more detail herein, the scope or range of the auditory pickup pattern or configuration 106 may change dynamically in order to accommodate different numbers of people conversing with user 104. Such changes may be initiated by head gestures of user 104 and/or may be initiated automatically by a wearable device such as smart glasses or goggles.

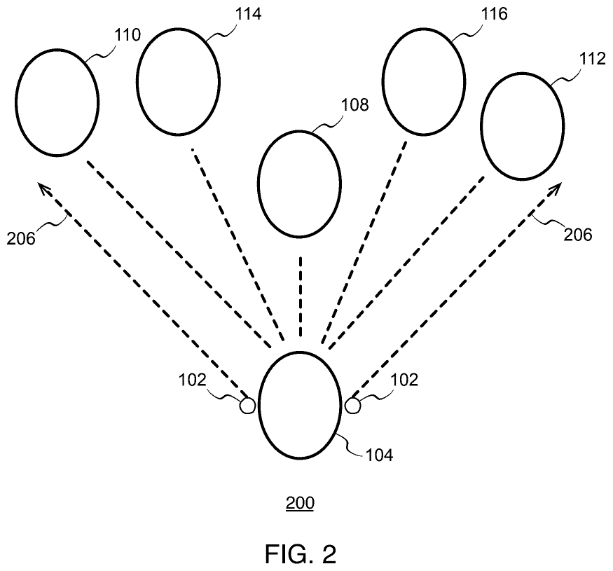

FIG. 2 is a top-view block diagram of an example environment 200 involving the control of hearables, where a user is speaking with multiple other people, according to some implementations. In various implementations, environment 200 includes system 102, which includes one or more hearing devices 102. As shown, hearing devices 102 may be worn by user 104.

In this example scenario, user 104 is conversing with multiple other people 108, 110, 112, 114, and 116. In an example scenario, user 104 may be initially talking with one other person 108 as shown in FIG. 1. At some point in the conversation, additional people such as persons 110 and 112 may join the conversation.

Subsequently, at another point in the conversation, additional people such as persons 114 and 116 may join the conversation. Individuals may dynamically enter and leave the conversation. The actual number of people in the conversation may change and vary at times depending on the particular circumstance.

As shown, the persons 108, 110, 112, 114, and 116 are positioned at different locations in front of user 104. In various implementations, the hearing devices 102 are each configured with an auditory pickup pattern or configuration. Such auditory pickup configurations are associated with a pattern for detecting audible sound such as voices from persons 108, 110, 112, 114, and 116.

As indicated herein, the auditory pickup configuration 106 is a pattern associated with detecting and receiving audio information such as a person's voice. Comparing auditory pickup configuration 106 of FIG. 1 to auditory pickup configuration 206 of FIG. 2, the former is narrower and the latter is broader. Auditory pickup configuration 106 of FIG. 1 is relatively narrow and is sufficiently large enough in range (e.g., 10 degrees, 15 degrees, 20 degrees, etc.) to pick up the voice of person 108. In contrast, auditory pickup configuration 206 of FIG. 2 is relatively wide or broad in range (e.g., 50 degrees, 70 degrees, 90 degrees, etc.) and is sufficiently large enough in range to pick up voices of multiple persons 108, 110, 112, 114, and 116 positioned at different locations in front of user 104.

For ease of illustration, auditory pickup configuration 106 of FIG. 1 and auditory pickup configuration 206 of FIG. 2 are shown with simplified dotted lines indicated the narrowing or widening of the scope or range of a given auditory pickup pattern or configuration. The actual auditory pickup configurations used may have any variety of shapes and patterns, depending on the types of microphones of hearing devices 102 that are used.

In various implementations, each of hearing devices 102 may include one or more of condenser microphones, dynamic microphones, directional microphones, omni-directional microphones, super-directional microphones, etc. As described in more detail herein, the particular types of microphones used may be changed and the scope or range of such microphones may be changed based on head gestures of the user and/or eye gestures of user.

As indicated above, there may be scenarios where user 104 is talking with multiple people such as persons 108, 110, 112, 114, and 116 while others are present but are not participating in the conversation. This may be, for example, a situation where user 104 is at a private or public gathering (e.g., event, party, etc.). Implementations described herein accommodate different situations, where the system may enhance the auditory pickup of people who are actually participating in a given conversation at a given moment, and where the system may attenuate the auditory pickup of those who are not participating in the given conversation.

As shown, FIGS. 1 and 2 are top-view diagrams. The widening and/or narrowing in the scope or range of an auditory pickup may be referred to as a change or modification in the lateral or horizontal range. From the perspective of user 104, the change or modification of the auditory pickup configuration is of a horizontal or lateral nature.

In various implementations, there may be multiple components to an auditory pickup configuration. For example, the notion of a lateral or horizontal component has been introduced above. This may be a scenario where multiple people in a given conversation are spread from side-to-side in front of user 104. As such, the particular sources of the sounds of the voices may vary in the lateral or horizontal direction.

In various implementations, there may also be a vertical component. This may be a scenario where multiple people in a given conversation have different heights. For example, person 108 may have a given height. Person 112 may be taller than person 108. Person 116 may be yet taller than person 112. Persons 110 and 114 may have any given heights that are shorter or taller than the others. As such, the particular sources of the sounds of the voices may vary in the vertical direction.

As described in more detail herein, such modifications of the auditory pickup configuration may include horizontal and/or vertical components. Such horizontal and/or vertical modifications of the auditory pickup configuration may be controlled by user gestures such as head movements or eye movements (e.g., eye gazes).

In various implementation, the system may change the auditory pickup configuration from a narrow auditory pickup configuration (e.g., a near-field or narrow focus), which is shown in FIG. 1 above, to a wide auditory pickup configuration (e.g., a far-field or wide focus) to accommodate for more people, which is shown in FIG. 2 above. Conversely, the system may change the auditory pickup configuration from a wide auditory pickup configuration (e.g., a wide focus) to a narrow auditory pickup configuration (e.g., a narrow focus) to accommodate for fewer people.

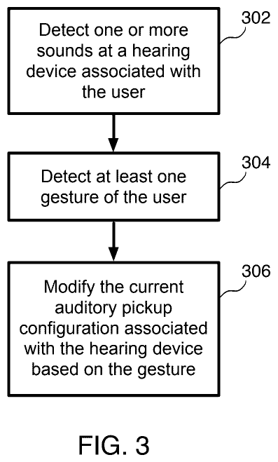

As described in more detail herein, the system enables user 104 to modify the scope or range of focus from narrow to wide or vice versus by using gestures such as head movements. Example implementations are described in more detail herein, in connection with FIG. 3, for example.

FIG. 3 is an example flow diagram for controlling hearables based on gestures of a user, according to some implementations. Referring to FIGS. 1, 2, and 3, a method is initiated at block 302, where a system including hearing devices 102 detects one or more sounds at hearing devices 102 associated with user 104. In various implementations, the one or more sounds may include voices. While a pair of hearing devices 102 may operate in concert, implementations described herein may apply to each hearing device 102 independently. As indicated above, for ease of illustration, system 102 may be referred to in the singular as hearing device 102 or may be referred collectively in the plural as hearing devices 102, depending on the context.

In various implementations, the sound sources are within a predetermined distance from the hearing device (e.g., within a conversational distance). The system is able to distinguish between the voice of user 104 and other voices. For example, the system may store information identifying the voice of user 104 during a set up or calibration phase.

At block 304, the system detects at least one gesture of the user. In various implementations, one or more gestures may be associated with one or more head movements of the user. In various implementations, a gesture may include three degrees of freedom. For example, user 104 may nod the user's head up and down to provide a change in pitch of hearing devices 102. In another example, user 104 may rotate the user's head left and right to provide a change in yaw of hearing devices 102. In another example, user 104 may lean the user's head left and right to provide a change in roll of hearing devices 102.

In various implementations, different sensors of each hearing device 102 may be used to sense particular movements or gestures. For example, sensors may include gyroscopes, accelerometers, magnetometers, etc., or any combination thereof. Gyroscopic sensors may enable a user to fix a source of a sound or voice that the microphones focus on while also enabling the user to move the user's head around to look at other things besides just a person speaking. In various implementations, the sensors may be calibrated per individual user per each session the hearables are worn.

In various implementations, there may be multiple gestures or head movements for a series of desired results. For example, the user may perform a first gesture or to modify the auditory pickup configuration (e.g., broaden the auditory pickup configuration, narrow the auditory pickup configuration, etc.). The user may subsequently perform a second gesture to turn off or disable the gesture controls, temporarily or otherwise. For example, a person may need to tilt their head upwards when speaking to a taller person. The user may not want to make any configuration changes during that time. In some implementations, the system may automatically distinguish between normal head movements versus head movements for configuration change. The user may subsequently perform a third gesture to turn on or enable the gesture controls. These are example gestures associated with example commands. The actual gestures and corresponding commands may vary, depending on the particular implementation. Other example gestures and associated commands are described in more detail herein.

At block 306, the system modifies the current auditory pickup configuration associated with hearing devices 102 based on the gesture. In various implementations, one or more gestures may correspond to one or more target auditory pickup configuration. In various implementations, the changes to the audio (e.g., auditory pickup configuration) may be caused not only by a change of microphone type and/or directivity pattern, but also caused by a change to the processing of the audio picked up from the microphone(s) to achieve the desired change to the sound output from the hearables such as hearing devices 102. For example, in various implementations, one or more gestures may correspond to one or more respective target microphone types, which has different associated auditory pickup configurations. For example, a leaning of the user's head to the left or right (e.g., left-right nod) may change the orientation of the hearing devices 102 (e.g., change in the roll or left-right or y/z plane). Such gestures or change in orientation may change the microphone type (e.g., condenser microphones, dynamic microphones, directional microphones, omni-directional microphones, super-directional microphones, etc.). This is one gesture example. Other gestures or combination of gestures describe herein may also cause a change in the microphone type.

Each microphone type may correspond to a different corresponding auditory pickup configuration or pattern. For example, some types of microphones (e.g., omni-directional microphones) may be better suited for far-field situations requiring wide range focus. Some types of microphones (e.g., directional microphones) may be better suited for mid-field situations. Some types of microphones (e.g., super-directional microphones) may be better suited for near-field situations requiring narrow range focus.

The particular types of microphones available may vary, depending on the particular implementation. As indicated above, other types of gestures in lieu of left-right nod may also cause such changes, depending on the particular implementation. For example, alternative gestures may include head nods, head rotations, etc.

In various implementations, the one or more gestures may correspond to one or more commands to increase a lateral range of the current auditory pickup configuration to a wider predetermined degree range. For example, in some implementations, a gesture may be associated with a horizontal head movement of the user. Such a horizontal head movement may be a rotation of the head of user 104, for example. A rotation may change the orientation of the hearing devices 102 (e.g., change in the yaw or left-right or x/y plane). Such a rotation may set the width of the auditory pickup configuration. For example, if user 104 nods while facing a first direction (e.g., facing toward one person such as person 110) and then nods while facing a second direction (e.g., facing toward a second person 112, the system may set the auditory pickup configuration to be wide, accordingly.

In various implementations, the system may lock the microphones on a particular sound target. As such, this enables the user to move the user's head around and not significantly affect the sound pick-up. The hearing devices or hearables may automatically boost the appropriate microphones while attenuating the appropriate microphones as the user's head moves around.

In some embodiments, the lateral or horizontal width or range may be based on the physical degree of rotation of the head of the user. For example, a wide rotation may result in a wide auditory pickup configuration. An even wider rotation may result in a yet wider auditory pickup configuration. This may lock the focus of the auditory pickup configuration to a particular group of sources or people (e.g., persons 108 to 116).

In various implementations, the system may attenuate sounds or voices that are outside the scope of the auditory pickup configuration (e.g., voices of people who are not participating in the conversation). In various implementations, as indicated above, locking down a given active scope of the auditory pickup configuration enables the user to look away from a given speaker and yet maintain the current auditory pickup configuration.

In some implementations, the hearing devices may sense the level of background noise and automatically change to directional microphones such that the hearables automatically focus on speech and sound coming from directly in front of them. The hearing devices may attenuate other directional voices/sounds not directly in front of the user. The user may decide other configurations with head movements.

In various implementations, one or more gestures may correspond to one or more commands to decrease a lateral range of the current auditory pickup configuration to narrower predetermined degree range. For example, in some implementations, a gesture may be associated with a vertical head movement of the user. Such a vertical head movement may be a nod of the head of user 104, for example. A nod may change the orientation of the hearing devices 102 (e.g., change in the pitch or up-down or x/z plane). Such a nod may set the width of the auditory pickup configuration. For example, if user 104 nods while facing one direction (e.g., facing toward one person such as person 108), the system may set the auditory pickup configuration to be narrow. This may lock the focus of the auditory pickup configuration to a particular source or person (e.g., person 108). In various implementations, the system may attenuate voices that are outside the scope of the auditory pickup configuration (e.g., voices of people who are not participating in the conversation).

In various implementations, the system may enable precise user-defined ranges of auditory pickup configurations, as described above. In some implementations, the system may enable predetermined increments of ranges of auditory pickup configurations (e.g., 15 degrees for conversations involving a single person, 30 degrees for conversations involving several persons, 180 degrees for conversations involving many persons. The predetermined increments may vary depending on the particular implementation. In some implementations, the system may enable the user to toggle or cycle through different range increments using a predetermined gesture or predetermined set of gestures. The gestures used to set such ranges may vary depending on the particular implementation.

The particular gesture or set of gestures or series of gestures used to modify the auditory pickup configuration may vary, depending on the particular implementation. In various implementations, there may be a predetermined number of gestures (e.g., number of left-right nods, number of left-right rotations, number of up-down nods, etc.) used to invoke a particular command. In various implementations, there may be a predetermined rate of change (e.g., slow, fast, etc.) of a particular gesture used to invoke a particular command. In various implementations, there may be a predetermined duration of change (e.g., long, quick, etc.) of a particular gesture used to invoke a particular command.

The following are additional examples of gestures for controlling or changing the auditory pickup configurations. In one example, if a talker were close to the user, the head of the user may tilt downward twice to focus the hearing devices in a narrow or near-field configuration. If another talker were further away, the head of the user may tilt downward twice more to change to a mid-range configuration, or twice more for a distance father way, then twice more to restore back to a narrow or near-field configuration setting, etc. In another example, the talker may be to the side of the user. In this case, the user may need to turn or rotate their head (left or right) to face the speaker to position the microphones to optimize the conversation. The user may then implement a head movement to optimize the auditory pickup configuration for the conversation. In another example, the user may tilt their head from side to side to disable the head movement tracking until another side-to-side movement enables head movement tracking.

While various implementations described herein may involve user gestures such as head nods, tilts, etc., other user indications are possible for modifying the auditory pickup configuration and/or changing microphones. For example, in some implementations, sounds such as a clicking sound made by the tongue of the user may be a means of controlling the hearing devices or hearables.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

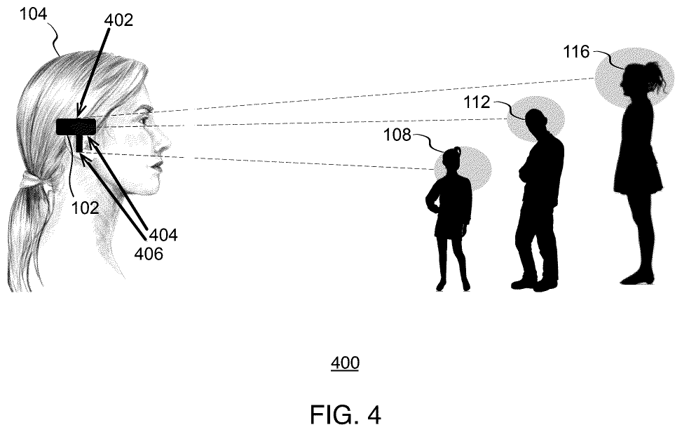

FIG. 4 is a side-view diagram of an example environment 400 involving the control of hearables, where a user is speaking with multiple other people, according to some implementations. In various implementations, environment 400 includes system 102, which includes one or two hearing devices 102. As indicated above, the terms system 102, hearing device 102, and hearing devices 102 may be used interchangeably, depending on the context. Hearing device 102, user 104, and persons 108, 112, and 116 may represent like elements as shown in FIG. 2.

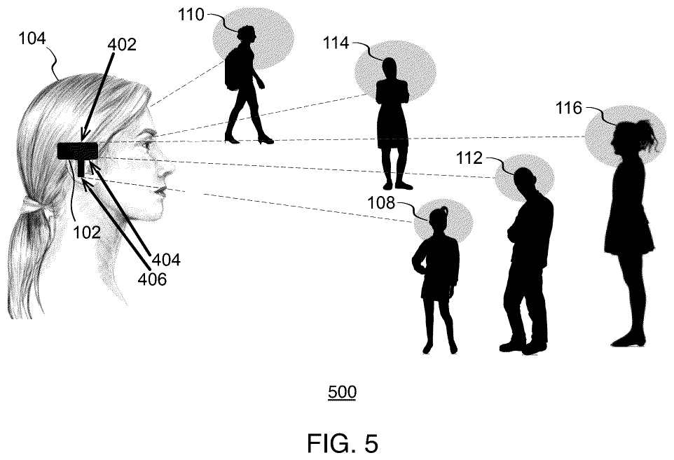

FIG. 5 is a side-view diagram of an example environment 500 involving the control of hearables, where a user is speaking with multiple other people, according to some implementations. In various implementations, environment 500 includes system 102, which includes one or two hearing devices 102, persons 108, 112, and 116. In addition, the example environment 500 also includes persons 110 and 114. This may be an example where the number of people in a given conversation with user 104 changes from moment to moment. Hearing device 102, user 104, and persons 108, 112, and 116 may represent like elements as shown in FIG. 2.

Referring to both FIGS. 4 and 5, hearing devices 102 are worn by user 104, where there is a right-side hearing device 102 worn on the right ear of user 104, and where there is a left-side hearing device (not shown) worn on the left ear of user 104. For ease of illustration, aspects of the right-side hearing device 102 is described below. These example implementations apply equally to both the left-and right-side hearing devices 102. As such, right-side hearing device 102 may also be referred to as hearing device 402.

In various implementations, hearing device 102 may include one or more microphones. In this particular example implementation, hearing device includes multiple microphones 402, 404, and 406. This set or series of microphones 402, 404, and 406 are arranged or configured vertically, where microphone 402 is positioned at or near the top of hearing device 102, microphone 404 is positioned at or near the vertical middle of hearing device 102, and microphone 406 is positioned at or near the bottom of hearing device 102. The exact positions of microphones 402, 404, and 406 may vary, depending on the particular implementation.

In various implementations, by having multiple microphones at varying vertical positions or levels, the different microphones may detect voices at vary heights. For example, the upper microphone 402 may be in an optimal position to detect and capture voices of taller people such as person 116. The lower microphone 406 may be in an optimal position to detect and capture voices of shorter people such as person 108. Also, there may be two or more different types of microphones (e.g., directional microphone, omni-directional microphone, etc.) operating on each hearing device. This provides vertical spatial separation of voice sources. This avoids a potential problem of the voices from multiple people being misinterpreted as a single source.

In various implementations, the different microphones 402, 404, and 406 are optimized with different auditory pickup configurations to capture voices of people in different horizontal and vertical positions. For example, right-side hearing device 102 is configured with one or more auditory pickup configurations to optimally capture voices sourced from the right of user 104. Conversely, left-side hearing device 102 is configured with one or more auditory pickup configurations to better optimally voices source from the left of user 104. As such, changing microphones may also change horizontal and/or vertical ranges of auditory pickup configurations.

While right-side hearing device 102 is optimized to capture voices sourced from the right of user 104, right-side hearing device 102 may also capture voices sourced from the left of user 104 even if less optimally. For example, right-side hearing device 102 may more readily and clearly pick up voices from persons 108, 112, and 116 who may be positioned in front of user 104 from around horizontal the middle of user 104 and to the right of user 104, for example. Right-side hearing device 102 may also pick up voices from persons 110 and 114 who are positioned in front of user 104 from around horizontal the middle of user 104 and to the left of user 104. Conversely, while left-side hearing device is optimized to capture voices sourced from the left of user 104, such as persons 110 and 114, the left-side hearing device may also capture voices sourced from the right of user 104, such as persons 108, 112, and 116 even if less optimally.

In various embodiments, the microphones 402, 404, and 406 may be different types of microphones. For example, microphones 402, 404, and 406 may be condenser microphones, dynamic microphones, directional microphones, omni-directional microphones, super-directional microphones, or any combination thereof. These are example types of microphones. The types of microphones used may vary, depending on the particular implementation. The number of microphones used in a given hearing device may vary, depending on the particular implementation.

Each microphone may be a dedicated particular dedicated type of microphone. Alternatively, the directivity and other measured inputs of a given microphone may be adjusted via software. The particular techniques for providing particular types of microphones may vary, depending on the particular implementation.

FIG. 6 is a top-view block diagram of an example environment 600 involving the control of hearables, where a user is speaking with multiple other people, according to some implementations. In various implementations, environment 600 includes system 102, which includes one or two hearing devices 102. As shown, hearing devices 102 may be worn by user 104.

Also shown is a wearable device 602, which is also worn by user 104. In various implementations, the wearable device includes eyewear, such as smart glasses or goggles. While hearing devices 102 may also be categorized as wearable devices, for ease of illustration, the term wearable device as described herein is used to refer to eyewear such as wearable 602 to avoid confusion and to distinguish wearable 602 from hearables or hearing devices 102.

Similar to the scenario described in connection with FIGS. 1 and 2, the widening and/or narrowing of the pattern or range of the auditory pickup configuration(s) may be controlled by user gestures such as head movements, as described herein. In addition to or in lieu of head movements, the widening and/or narrowing of the pattern or range of the auditory pickup configuration(s) may be controlled automatically without human intervention or in addition to human intervention by the wearable device 602.

In this example scenario, user 104 is conversing with multiple other people 108, 110, 112, 114, and 116, similar to the scenario of FIG. 2. Individuals may dynamically enter and leave the conversation. The actual number of people in the conversation may change and vary at times depending on the particular circumstance.

As shown, the people 108, 110, 112, 114, and 116 are positioned in front of user 104. In various implementations, the hearing devices 102 are each configured with an auditory pickup pattern or configuration. As indicated herein, such auditory pickup configurations are associated with patterns for detecting audible sound such as voices from a range people, such a persons 108, 110, 112, 114, and 116.

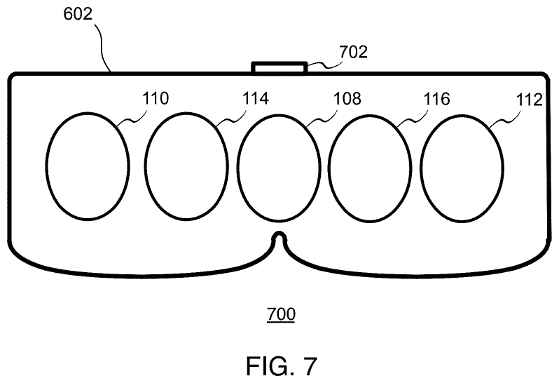

FIG. 7 is a block diagram of an example environment 700 involving the control of hearables, where a user is speaking with multiple other people as seen through a wearable device, according to some implementations. The scenario shown in FIG. 7 corresponds to the scenario shown in FIG. 6. Shown is wearable device 602 through which the user sees other people such as persons 110, 114, 108, 116, and 112.

Wearable device 602 includes a camera 702. While camera 702 is shown at the top center of wearable device 602, the position of camera 702 on wearable device 602 may vary, depending on the particular implementation. In this example implementation, camera 702 may have multiple lenses aimed in different directions. For example, camera 702 may have a lens that aims outward to capture images of other people such as persons 110, 114, 108, 116, and 112. Camera 702 may also have a lens that aims inward to capture images of the eyes and/or gaze of the eyes of the user. For ease of illustration, one camera 702 is described for the capturing of such objects (e.g., people, eye gaze, etc.). In other implementations, there may be multiple cameras. For example, one camera may be dedicated for capturing people that the user is viewing, and another camera may be dedicated for capturing the eyes and/or gaze of the eyes of the user.

The following implementations describe scenarios where wearable device 602 provides horizontal and vertical conversation focusing using eye tracking. In various implementations, wearable device 602 determines appropriate auditory pickup configurations for a variety of situations involving different numbers of participants in a conversation with the user, including their different relative locations and heights.

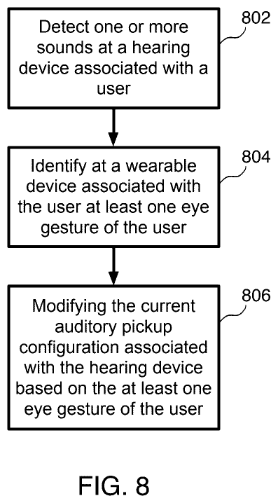

FIG. 8 is an example flow diagram for providing horizontal and vertical conversation focusing using eye tracking, according to some implementations. Referring to FIGS. 6, 7, and 8, a method is initiated at block 802, where a system such as system 102 detects one or more sounds at hearing device 102 associated with user 104. In various implementations, the sound sources are within a predetermined distance from the hearing device (e.g., within a conversational distance). In various implementations, the one or more sounds may include voices. In various implementations, the system is able to distinguish between the voice of user 104 and other voices. For example, the system may store information identifying the voice of user 104 during a set up or calibration phase.

At block 804, the system identifies at wearable device 602 associated with user 104 one or more eye gestures of user 104. As indicated herein, the system includes a combination of hearing devices 102 and wearable device 602, which work in concert. As described in more detail below, in various implementations, the system modifies the current auditory pickup configuration based on the number of the people communicating with user 104. The system may also modify the auditory pickup configuration based on positions of the people. The wearable device 602 assesses the conversational situation (e.g., number of people, locations of people, etc.) and communicates such information to hearing devices 102 to cause hearing devices 102 to modify their respective auditor pickup configurations.

In various embodiments, the system may detect faces via camera 702 for face detection and reading lip movement of the faces. The system may use face detection to determine which people are facing a user. The wearable device 602 may perform face recognition and determine who the primary speaker is. In some implementations, the system may enable lip reading, as well as interpreting American Sign Language. As the wearable device 602 determines the primary speaker, the wearable device 602 causes hearing devices 102 to modify their respective auditory pickup configurations, accordingly, to optimally pick up the voice of the primary speaker at the given moment. As the primary speaker changes, the system causes the auditory pickup configurations to change accordingly.

In various implementations, the system may utilize camera 702 to detect the faces that are in proximity to user 104, within a given speaking or conversational distance. The system may use any suitable proximity detection techniques such as using radar sensors, ultrasonic sensors, infrared sensors, etc. The system may use such information associated with lip movement and proximity to ascertain that the people captured such as persons 110-118 are in conversation with user 104.

In various implementations, the one or more eye gestures includes a gaze of the user in a direction toward one or more people positioned in front of the user. In various implementations, the system may determine that the people captured by camera 702 are in the conversation based on the gaze of the eyes of user 104. For example, as user 104 gazes at each of the persons 110-118, the system may correspond the person at whom user 104 looking to lip movement of that person. As such, the system may include that person in the group of peopled determined to be in the conversation.

In various implementations, the field of view through wearable device 602 may be divided up into quadrants. Such quadrants may radially branch out from wearable device 602. The quadrants are used by the system to determine horizontal and vertical targets to focus on. The system tracks the eyes or gaze of user 104 and maps the gaze to particular quadrants to focus or optimize the auditory pickup configurations on a particular person speaking. In various implementations, the quadrant that user 104 is looking at is communicated by wearable device 602 to hearing devices 102. Hearing devices 102 may then adjust their respective auditory pickup configurations to focus the audio or auditory pickup configuration horizontally and/or vertically at the primary or target speaker. As such, the system helps to steer the listening of user 104 towards a primary or target speaker when multiple people are speaking.

Referring still to FIG. 8, at block 806, the system modifies a current auditory pickup configuration associated with the hearing device based on the at least one eye gesture of the user. In various implementations, the one or more eye gestures correspond to a command to modify the current auditory pickup configuration to a target auditory pickup configuration. Such a modification may be to accommodate multiple people in conversations, where the different people may have varying horizontal positions (e.g., where given persons is standing) relative to user 104, and varying vertical positions relative to user 104 (e.g., heights of given persons).

In various implementations, the eye gesture may correspond to at least one target auditory pickup configuration. In various implementations, the auditory pickup configuration includes one or more of a horizontal range and a vertical range. For example, the auditory pickup configuration may be configured to capture multiple people such as persons 110-118 spanning a lateral or horizontal range (e.g., from left to right). Similarly, the auditory pickup configuration may be configured to capture multiple people such as persons 110-118 having different heights and spanning a vertical range (e.g., from higher to lower). Each auditory pickup configuration corresponds to different combinations of people along a horizontal range and a vertical range.

In various implementations, the one or more eye gestures corresponds to a command to switch from a current microphone type to a target microphone type. In various implementations, the eye gesture may correspond to at least one target microphone type. In various implementations, each microphone type corresponds to an auditory pickup pattern or configuration that may accommodate voices from speakers of varying positions in the horizontal and vertical directions.

In various implementations, the system tracks at the wearable device one or more people positioned in front of the user. In various implementations, the one or more people respectively correspond to the sound sources of the one or more voices. In various implementations, the modifying of the current auditory pickup configuration is based on a number of the one or more people. In various implementations, the eye gesture may correspond to a command to modify a range of the auditory pickup configuration to a predetermined target range.

In various implementations, the range of the auditory pickup configuration may include a horizontal range and a vertical range. In various implementations, the eye gesture may correspond to a command to increase the horizontal range and/or vertical range of the auditory pickup configuration to a broader or wider predetermined degree range. In various implementations, the eye gesture may correspond to a command to decrease the horizontal range and/or vertical range of the auditory pickup configuration to narrower predetermined degree range.

The following are example use cases. In some scenarios, a user may start to wear various types of smart glasses or goggles for virtual reality and augmented reality. These glasses (e.g., wearable device 602, etc.) may track the eyes or gaze of the user to ascertain where the user is focusing their attention. Wearable device 602 may communicate to hearing devices 102 a signal that indicates that a person speaking is to the front, left or right of the speaker, as well as the distance between the speaker and the user. In another example, wearable device 602 may determine a distance of a speaker, and hearing devices 102 using multiple microphones may determine the direction to focus the listening experience (e.g., near-field, mid-field, and far-field, etc.). The wearable device 602 and hearing devices 102 work together in concert to create the best possible experience for the user.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations enable a user to modify the auditory pickup configuration quickly and conveniently without having to access and manipulate an auxiliary device such a smart phone. Implementations described herein also make is easier for hearables to make directionality adjustments to make conversation more focused and easier to understand. Implementations described herein also utilize both hearing devices (hearables) and wearables together in concert to create a synergistic approach to creating a better listening/conversational experience for a user. As the user moves their eyes and/or head around during group conversations, the hearing device and wearable device technology steers the conversation to where the user wishes to focus. This can be important if there is more than one conversation going on at the same time.

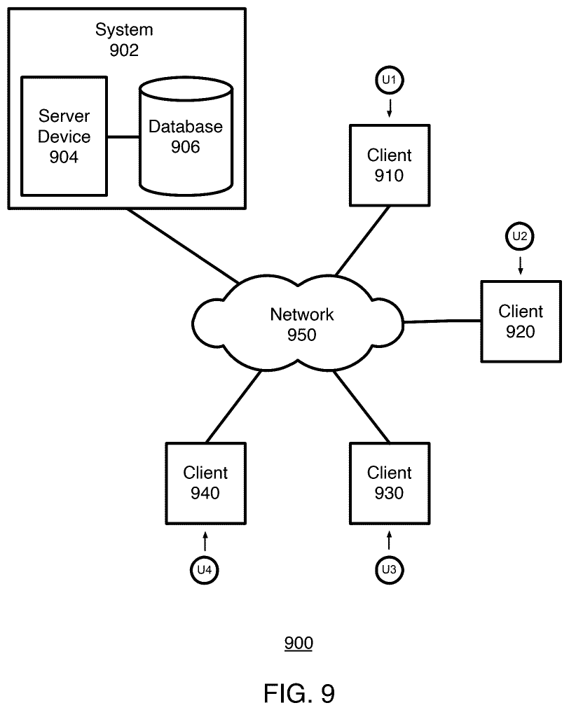

FIG. 9 is a block diagram of an example network environment 900, which may be used for some implementations described herein. In some implementations, network environment 900 includes a system 902, which includes a server device 904 and a database 906. For example, system 902 may be used to implement system 102 of FIG. 1 and other figures, as well as to perform implementations described herein. Network environment 900 also includes client devices 910, 920, 930, and 940, which may communicate with system 902 and/or may communicate with each other directly or via system 902. Network environment 900 also includes a network 950 through which system 902 and client devices 910, 920, 930, and 940 communicate. Network 950 may be any suitable communication network such as a Wi-Fi network, Bluetooth network, the Internet, etc.

For ease of illustration, FIG. 9 shows one block for each of system 902, server device 904, and network database 906, and shows four blocks for client devices 910, 920, 930, and 940. Blocks 902, 904, and 906 may represent multiple systems, server devices, and network databases. Also, there may be any number of client devices. In other implementations, environment 900 may not have all of the components shown and/or may have other elements including other types of elements instead of, or in addition to, those shown herein.

While server device 904 of system 902 performs implementations described herein, in other implementations, any suitable component or combination of components associated with system 902 or any suitable processor or processors associated with system 902 may facilitate performing the implementations described herein.

In the various implementations described herein, a processor of system 902 and/or a processor of any client device 910, 920, 930, and 940 cause the elements described herein (e.g., information, etc.) to be displayed in a user interface on one or more display screens.

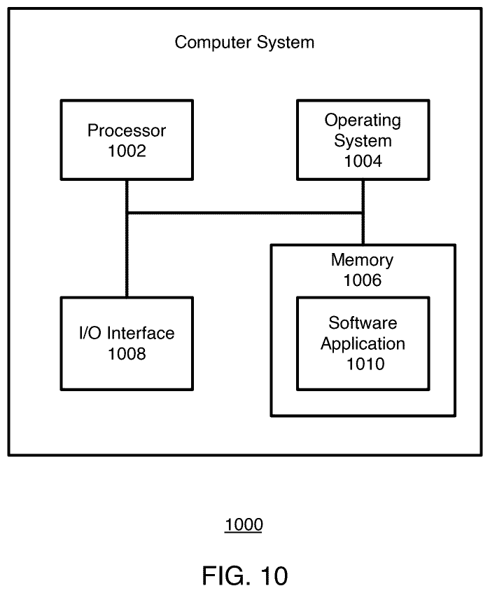

FIG. 10 is a block diagram of an example computer system 1000, which may be used for some implementations described herein. For example, computer system 1000 may be used to implement system device 902 of FIG. 9 and/or system 102 of FIG. 1 and other figures, as well as to perform implementations described herein. In some implementations, computer system 1000 may include a processor 1002, an operating system 1004, a memory 1006, and an input/output (I/O) interface 1008. In various implementations, processor 1002 may be used to implement various functions and features described herein, as well as to perform the method implementations described herein. While processor 1002 is described as performing implementations described herein, any suitable component or combination of components of computer system 1000 or any suitable processor or processors associated with computer system 1000 or any suitable system may perform the steps described. Implementations described herein may be carried out on a user device, on a server, or a combination of both.

Computer system 1000 also includes a software application 1010, which may be stored on memory 1006 or on any other suitable storage location or computer-readable medium. Software application 1010 provides instructions that enable processor 1002 to perform the implementations described herein and other functions. Software application may also include an engine such as a network engine for performing various functions associated with one or more networks and network communications. The components of computer system 1000 may be implemented by one or more processors or any combination of hardware devices, as well as any combination of hardware, software, firmware, etc.

For ease of illustration, FIG. 10 shows one block for each of processor 1002, operating system 1004, memory 1006, I/O interface 1008, and software application 1010. These blocks 1002, 1004, 1006, 1008, and 1010 may represent multiple processors, operating systems, memories, I/O interfaces, and software applications. In various implementations, computer system 1000 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
identifying at a wearable device associated with a user at least one eye gesture of the user; and
modifying a current auditory pickup configuration associated with a hearing device based on the at least one eye gesture of the user, wherein the hearing device is configured to detect one or more sounds, and wherein the current auditory pickup configuration comprises one or more of a horizontal range and a vertical range.

2. The system of claim 1, wherein the wearable device comprises eyewear.

3. The system of claim 1, wherein the at least one eye gesture comprises a gaze of the user in a direction toward one or more people positioned in front of the user.

4. The system of claim 1, wherein the at least one eye gesture corresponds to a command to modify the current auditory pickup configuration to a target auditory pickup configuration.

5. (canceled)

6. The system of claim 1, wherein the at least one eye gesture corresponds to a command to switch from a current microphone type to a target microphone type.

7. The system of claim 1, wherein the logic when executed is further operable to cause the one or more processors to perform operations comprising tracking at the wearable device one or more people positioned in front of the user, wherein the one or more people respectively correspond to one or more voices associated with the one or more sounds, and wherein the modifying of the current auditory pickup configuration is based on a number of the one or more people.

8. A non-transitory computer-readable storage medium with program instructions stored thereon, the program instructions when executed by one or more processors are operable to cause the one or more processors to perform operations comprising:
identifying at a wearable device associated with a user at least one eye gesture of the user; and
modifying a current auditory pickup configuration associated with a hearing device based on the at least one eye gesture of the user, wherein the hearing device is configured to detect one or more sounds, and wherein the current auditory pickup configuration comprises one or more of a horizontal range and a vertical range.

9. The computer-readable storage medium of claim 8, wherein the wearable device comprises eyewear.

10. The computer-readable storage medium of claim 8, wherein the at least one eye gesture comprises a gaze of the user in a direction toward one or more people positioned in front of the user.

11. The computer-readable storage medium of claim 8, wherein the at least one eye gesture corresponds to a command to modify the current auditory pickup configuration to a target auditory pickup configuration.

12. (canceled)

13. The computer-readable storage medium of claim 8, wherein the at least one eye gesture corresponds to a command to switch from a current microphone type to a target microphone type.

14. The computer-readable storage medium of claim 8, wherein the instructions when executed are further operable to cause the one or more processors to perform operations comprising tracking at the wearable device one or more people positioned in front of the user, wherein the one or more people respectively correspond to one or more voices associated with the one or more sounds, and wherein the modifying of the current auditory pickup configuration is based on a number of the one or more people.

15. A computer-implemented method comprising:
identifying at a wearable device associated with a user at least one eye gesture of the user; and
modifying a current auditory pickup configuration associated with a hearing device based on the at least one eye gesture of the user, wherein the hearing device is configured to detect one or more sounds, and wherein the current auditory pickup configuration comprises one or more of a horizontal range and a vertical range.

16. The method of claim 15, wherein the wearable device comprises eyewear.

17. The method of claim 15, wherein the at least one eye gesture comprises a gaze of the user in a direction toward one or more people positioned in front of the user.

18. The method of claim 15, wherein the at least one eye gesture corresponds to a command to modify the current auditory pickup configuration to a target auditory pickup configuration.

19. (canceled)

20. The method of claim 15, wherein the at least one eye gesture corresponds to a command to switch from a current microphone type to a target microphone type.
